(19) United States
(12) Patent Application Publication
(10) Pub. No.: US 2026/0322929 A1
(43) Pub. Date: Oct. 15, 2026

(54) SHEET RECYCLING SYSTEM AND MANAGEMENT DEVICE

(71) Applicant: SEIKO EPSON CORPORATION, Tokyo (JP)

(72) Inventors: Yuji MISAWA, Matsumoto-shi (JP); Masaki SHIMOMURA, Matsumoto-shi (JP); Tetsuji YATSUNAMI, Okaya-shi (JP); Kazuhisa KAWAKAMI, Matsumoto-shi (JP); Takuto TANAKA, Shiojiri-shi (JP); Yusuke KOMIYAMA, Matsumoto-shi (JP); Ayako TANABE, Matsumoto-shi (JP); Asuka SUGIHARA, Shiojiri-shi (JP)

(21) Appl. No.: 19/648,568

(22) Filed: Apr. 15, 2026

(30) Foreign Application Priority Data
Apr. 15, 2025 (JP) 2025-067000

(51) Int. Cl. H04N 1/00; H04N 1/34

(52) U.S. Cl. CPC H04N 1/00641; H04N 1/00716; H04N 1/346

(57) ABSTRACT

A sheet recycling system includes a sheet manufacturing device that processes a processable sheet suitable for recycling to produce a recycled sheet; a printing device configured to print on the recycled sheet manufactured by the sheet manufacturing device; and a management section that is configured to acquire first information related to print content for when the printing device performs printing and second information related to an amount of the processable sheet and that is configured to generate third information related to a billing amount based on the first information and the second information.

The present application is based on, and claims priority from JP Application Serial Number 2025-067000, filed Apr. 15, 2025, the disclosure of which is hereby incorporated by reference herein in its entirety.

### BACKGROUND

### 1. Technical Field

The present disclosure relates to a sheet recycling system including a sheet manufacturing device that manufactures a recycled sheet, a printing device that performs printing on the recycled sheet, and a management device that calculates a billing amount. The present disclosure also relates to a management device that calculates a billing amount when printing is performed using a printing device in a sheet recycling system.

### 2. Related Art

As disclosed in JP-A-2023-116011, in the related art, a dry-type sheet manufacturing device is known in which used paper is shredded into coarse fragments, the coarse fragments are defibrated, the defibrated material is deposited on a flat surface, and the deposited material is then heated and pressurized to obtain a sheet-shaped recycled sheet.

The sheet manufacturing device described in JP-A-2023-116011 recycles used sheets, and therefore it is preferable to further promote the use from the viewpoint of environmental protection. In this case, it is desirable that the system is user-friendly.

### SUMMARY

In order to solve the above-described problem, a sheet recycling system of the present disclosure includes a sheet manufacturing device configured to process a processable sheet suitable for recycling into a recycled sheet; a printing device configured to print on the recycled sheet manufactured by the sheet manufacturing device; and a management section that is configured to acquire first information related to print content for when the printing device performs printing and second information related to an amount of the processable sheet and that is configured to generate third information related to a billing amount based on the first information and the second information.

According to the present disclosure, a management device configured to calculate a billing amount for printing by the printing device in a sheet recycling system including a sheet manufacturing device that processes a processable sheet suitable for recycling to produce a recycled sheet and a printing device that prints on the recycled sheet manufactured by the sheet manufacturing device, wherein the management device acquires first information related to print content when printing is performed using the printing device and second information related to an amount of the processable sheet and generates third information related to the billing amount based on the first information and the second information.

### BRIEF DESCRIPTION OF THE DRAWINGS

FIG. 1 is a diagram illustrating an overall configuration of a sheet recycling system.

FIG. 2 is a diagram illustrating an internal configuration of a sorting device and a coarse shredding device.

FIG. 3 is a diagram illustrating an internal configuration of the sheet manufacturing device.

FIG. 4 is a diagram illustrating an internal configuration of the printing device.

FIG. 5 is a block diagram illustrating a configuration of a management section and a configuration of a device connected to the management section.

FIG. 6 is a flowchart illustrating a relationship between a user operation and processing or an operation of the sheet recycling system.

FIG. 7 is a flowchart illustrating a flow of calculation of a billing amount.

FIG. 8 is a diagram illustrating a configuration of a billing amount.

FIG. 9 is a diagram illustrating an internal configuration of a printing device and a relay device according to another embodiment.

### DESCRIPTION OF EMBODIMENTS

Hereinafter, the present disclosure will be schematically described.

A sheet recycling system according to a first aspect includes a sheet manufacturing device configured to process a processable sheet suitable for recycling into a recycled sheet; a printing device configured to print on the recycled sheet manufactured by the sheet manufacturing device; and a management section that is configured to acquire first information related to print content for when the printing device performs printing and second information related to an amount of the processable sheet and that is configured to generate third information related to a billing amount based on the first information and the second information.

According to this aspect, since the management section generates the third information related to the billing amount based on the first information and the second information, the user can receive a benefit that the billing amount when printing is performed using the printing device is reduced according to the amount of the processable sheets. Therefore, it is possible to encourage the user to use the sheet manufacturing device, and it is possible to contribute to environmental protection.

Since the management section generates the third information related to the billing amount based on the first information and the second information, the user can casually use the sheet recycling system each time without using a complicated mechanism such as user authentication, and a system convenient for the user can be configured.

A second aspect is an aspect according to the first aspect, further including a sorting device configured to sort processable sheets and non-processable sheets, which are unsuitable for recycling by the sheet manufacturing device.

According to this aspect, since the sheet recycling system includes the sorting device that sorts the processable sheet and the non-processable sheet, the recycled sheet can be appropriately manufactured by the sheet manufacturing device. The user or the system administrator does not need to sort the processable sheet and the non-processable sheet by himself/herself, and usability is improved.

A third aspect is an aspect according to the second aspect, when the number of recycled sheets manufacturable by the sheet manufacturing device is equal to or greater than a number of sheets required for printing by the printing device, the management section sets at least a sheet fee included in the billing amount to zero.

According to this aspect, when the number of sheets required for printing using the printing device is equal to or less than the number of recycled sheets that can be manufactured by the sheet manufacturing device, the management section sets at least the sheet fee included in the billing amount to zero, and thus it is possible to encourage the user to use the sheet manufacturing device and contribute to environmental protection.

Note that the present aspect is not limited to the second aspect, and may be dependent to the first aspect.

A fourth aspect is an aspect according to the third aspect, when the number of recycled sheets manufacturable by the sheet manufacturing device exceeds the number required for printing by the printing device, the management section determines payment of money or provision of a predetermined service to a user according to the number of sheets exceeding the number required for printing by the printing device.

According to the present aspect, the management section determines payment of money or provision of a predetermined service to a user according to the number of sheets that exceeds the number of sheets required for printing using the printing device in a case where the number of recycled sheets that can be manufactured by the sheet manufacturing device exceeds the number of sheets required for printing using the printing device, and thus it is possible to further encourage the user to use the sheet manufacturing device and to further contribute to environmental protection.

A fifth aspect is an aspect according to the second aspect, the printing device is configured to store a non-manufactured sheet that is not manufactured by the sheet manufacturing device and selectively feed the recycled sheet and the non-manufactured sheet.

According to this aspect, since the non-manufactured sheet that is not manufactured by the sheet manufacturing device can be stored and the recycled sheet and the non-manufactured sheet can be selectively fed, the sheet to be used for printing can be selected according to the preference of the user, and the usability is improved.

This aspect is not limited to the second aspect, and may depend on any one of the first, third, and fourth aspects.

A sixth aspect is an aspect according to the fifth aspect, wherein the management section sets the billing amount for printing with the recycled sheet to be lower than the billing amount for printing with the non-manufactured sheet.

According to the present aspect, since the management section sets the billing amount for printing using the recycled sheet to be lower than the billing amount for printing using the non-manufactured sheet, it is possible to further encourage the user to use the recycled sheet and to further contribute to environmental protection.

A seventh aspect is an aspect according to the second aspect, a supply section configured to supply the recycled sheet from the sheet manufacturing device to the printing device.

According to the present aspect, since a supply section that supplies the recycled sheet from the sheet manufacturing device to the printing device, a user or a system administrator does not need to set the recycled sheet in the printing device by himself/herself, and usability is improved.

This aspect is not limited to the second aspect, and may depend on the first aspect or any one of the third to sixth aspects.

An eighth aspect is an aspect according to the second aspect, wherein the sorting device includes an optical sensor having a light emitting section that emits detection light toward the sheet and a light receiving section that detects reflected light from the sheet and when intensity of the reflected light is less than a predetermined threshold, the management section determines that the sheet is the processable sheet.

According to this aspect, the optical sensor can exclude a sheet not suitable for recycling, for example, glossy paper.

Note that, the present aspect is not limited to the second aspect and may be according to any of the third to seventh aspects.

A ninth aspect is an aspect according to the second aspect, wherein the sorting device includes a thickness detection section that detects a thickness of the sheet and the management section determines that the sheet is the processable sheet when the thickness of the sheet detected by the thickness detection section is less than a predetermined threshold value.

According to this aspect, the thickness detection section can exclude a sheet that is not suitable for recycling, for example, a dedicated paper.

The present aspect is not limited to the second aspect and may be according to any one of the third to eighth aspects.

A tenth aspect is an aspect according to the second aspect, wherein the sorting device includes a discharge section configured to discharge the non-processable sheet.

According to the present aspect, since the sorting device includes a discharge section configured to discharge the non-processable sheet, the user can take the non-processable sheet home, which improves usability.

The present aspect is not limited to the second aspect and may be according to any one of the third to ninth aspects.

According to eleventh aspect, a management device configured to calculate a billing amount for printing by the printing device in a sheet recycling system including a sheet manufacturing device that processes a processable sheet suitable for recycling to produce a recycled sheet and a printing device that prints on the recycled sheet manufactured by the sheet manufacturing device, wherein the management device acquires first information related to print content when printing is performed using the printing device and second information related to an amount of the processable sheet and generates third information related to the billing amount based on the first information and the second information.

According to this aspect, since the management device generates the third information related to the billing amount based on the first information and the second information, the user can receive a benefit that the billing amount when performing printing using the printing device is reduced according to the amount of the processable sheets. Therefore, it is possible to encourage the user to use the sheet manufacturing device, and it is possible to contribute to environmental protection.

Since the management device generates the third information related to the billing amount based on the first information and the second information, the user can casually use the sheet recycling system each time without using a complicated mechanism such as user authentication, and a system convenient for the user can be configured.

The present disclosure will be described in detail below.

An X-Y-Z coordinate system illustrated in each drawing is an orthogonal coordinate system, and a direction indicated by an arrow is a + direction and the opposite direction is a - direction. The Y-axis direction is a depth direction of the device and the system, the +Y direction is a direction from the rear surface to the front surface of the device and the system, and the -Y direction is a direction from the front surface to the rear surface of the device and the system.

The X-axis direction is a width direction of the device and the system, and the +X direction is a left direction and the -X direction is a right direction as viewed from a user facing the device and the system.

The Z-axis direction is a vertical direction, that is, a height direction of the device and the system, and the +Z direction is an upward direction and the -Z direction is a downward direction.

### Configuration of Sheet Recycling System

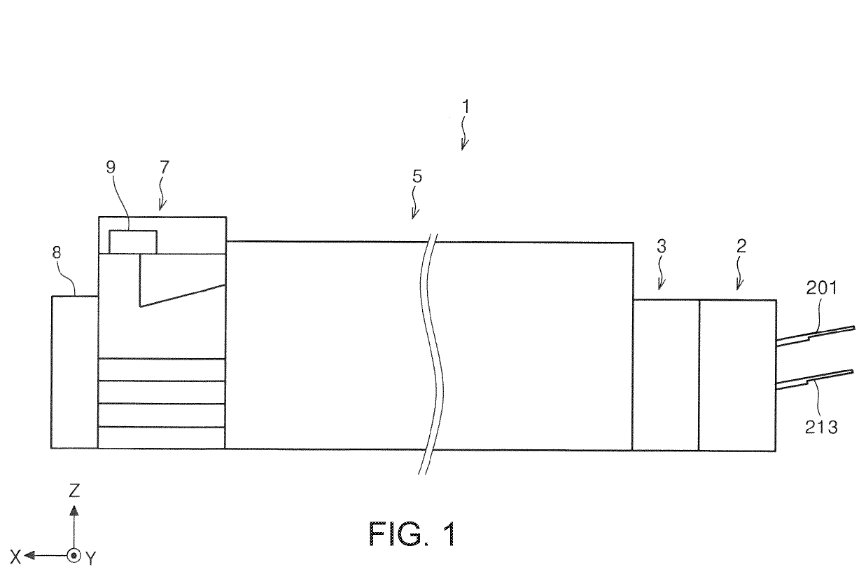

FIG. 1 illustrates an overall configuration of a sheet recycling system 1. The sheet recycling system 1 according to the present embodiment is assumed to be installed in a store and, more specifically, is assumed to be installed in a convenience store. However, the sheet recycling system 1 may be installed not only in small-scale stores but also in large-scale stores such as shopping malls, in facilities providing public services such as libraries, or in schools, companies, and similar locations.

As illustrated in FIG. 1, the sheet recycling system 1 includes a sorting device 2, a coarse shredding device 3, a sheet manufacturing device 5, a printing device 7, and a payment device 8 in this order along the +X direction. In the present embodiment, each device is configured as an independent device, and adjacent devices are interconnected by a connection unit (not illustrated). However, the sheet recycling system 1 is not limited to such a configuration, and all of the respective devices may be integrally provided and configured as one device as a whole, or any two or more devices may be integrally provided and configured as one device.

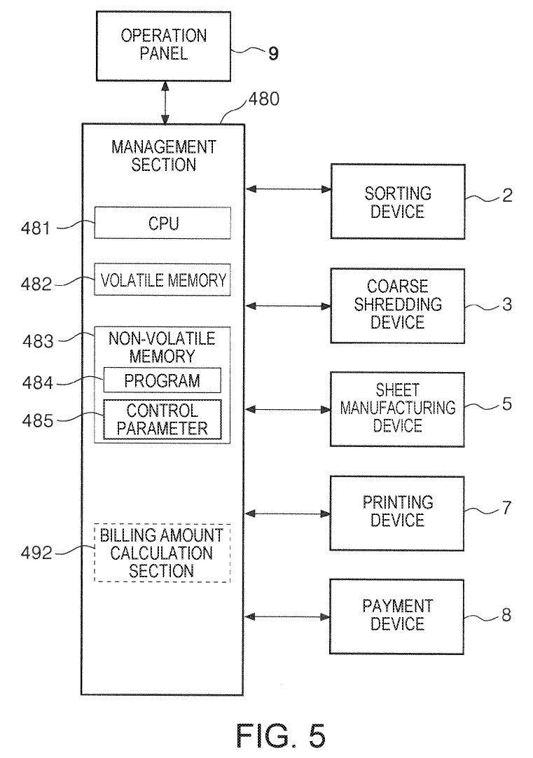

The above-described devices, that is, the entire operation of the sheet recycling system 1 is controlled by a management section 480 (to be described later, see FIG. 5).

The sorting device 2 includes a feed tray 201 for setting used sheets brought by a user. The sorting device 2 sorts the sheets set in the feed tray 201 into sheets suitable for the recycling process by the sheet manufacturing device 5 and sheets not suitable for the recycling process. Hereinafter, a sheet suitable for the recycling process by the sheet manufacturing device 5 is referred to as a processable sheet Sa, and a sheet not suitable for the recycling process by the sheet manufacturing device 5 is referred to as a non-processable sheet Sb. Reference numeral 213 denotes a discharge tray (to be described later).

The coarse shredding device 3 receives the processable sheet Sa from the sorting device 2, performs a shredding process, and the coarse fragments generated by the shredding process are sent to the sheet manufacturing device 5.

The sheet manufacturing device 5 receives the coarse fragments from the coarse shredding device 3, performs a recycling process, and manufactures a recycled sheet. Hereinafter, the recycled sheet manufactured by the sheet manufacturing device 5 is denoted by reference numeral Sr and is referred to as a recycled sheet Sr.

The printing device 7 receives the recycled sheet Sr from the sheet manufacturing device 5 and performs printing. The printing device 7 according to the present embodiment can accommodate a non-manufactured sheet that was not manufactured by the sheet manufacturing device 5. Hereinafter, a non-manufactured sheet is denoted by reference numeral Sd and is referred to as a non-manufactured sheet Sd.

The non-manufactured sheet Sd is, for example, a copy sheet having a higher whiteness than the recycled sheet Sr. The printing device 7 can select the recycled sheet Sr and the non-manufactured sheet Sd as the medium on which printing is performed based on the user instruction. Reference numeral 9 denotes an operation panel (to be described later).

The configurations of the sorting device 2, the coarse shredding device 3, the sheet manufacturing device 5, and the printing device 7 will be described in more detail later.

The payment device 8 is a device for the user to pay the usage fee of the sheet recycling system 1, and receives payment of the usage fee by the user by at least one of, for example, a coin, a bill, electronic money, and a credit card. The payment device 8 has, for example, a coin slot and a bill slot (not illustrated). The payment device 8 has a card reader (not illustrated) for receiving electronic money from an IC card, for example. The payment device 8 has a magnetic reader (not illustrated) for performing settlement processing by a credit card, for example. The payment device 8 is not illustrated and described in detail herein.

### Configuration of Sorting Device and Coarse Shredding Device

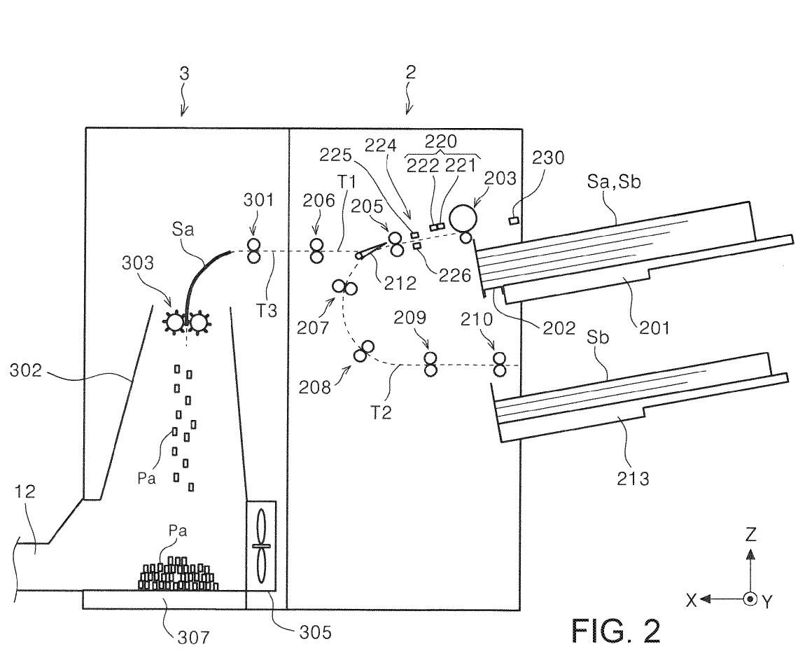

Next, the sorting device 2 and the coarse shredding device 3 will be described in detail with reference to FIG. 2.

The sorting device 2 includes a feed tray 201 for setting used sheets brought by a user. In many cases, the used sheets set on the feed tray 201 include both the processable sheet Sa and the non-processable sheet Sb.

A sheet sensor 230 is provided above the feed tray 201, and the management section 480 (to be described later, see FIG. 5) can detect the presence or absence of a sheet on the feed tray 201 based on detection information of the sheet sensor 230.

The sheet set on the feed tray 201 is pushed up by a lifter 202 and fed from the feed tray 201 by a feed roller pair 203.

An optical sensor 220 is provided downstream of the feed roller pair 203. The optical sensor 220 includes a light emitting section 221 that emits detection light to the sheet and a light receiving section 222 that detects reflected light reflected from the sheet. The management section 480 (to be described later, see FIG. 5) determines the glossiness of the sheet based on the detection information of the optical sensor 220.

The sorting device 2 can exclude a sheet not suitable for recycling, for example, glossy paper, by using such the optical sensor 220.

A thickness detection section 224 that detects the thickness of the sheet is provided downstream of the optical sensor 220. The thickness detection section 224 can use a known thickness detection means as appropriate, and is configured by an ultrasonic sensor in the present embodiment as an example. Specifically, the thickness detection section 224 includes a transmitting section 225 and a receiving section 226 that are disposed to face each other with the sheet transport path interposed therebetween.

The transmitting section 225 emits ultrasonic waves. The receiving section 226 receives the ultrasonic wave emitted from the transmitting section 225. The ultrasonic wave penetrates the sheet to be transported. The receiving section 226 outputs a reception signal corresponding to the sound pressure of the received ultrasonic wave to the management section 480 (to be described later, see FIG. 5). Thus, the management section 480 determines the thickness of the sheet based on the signal strength of the received signal.

The sorting device 2 can exclude a sheet not suitable for recycling, for example, a dedicated paper having a thickness larger than a predetermined value, by the thickness detection section 224.

Then, the management section 480 (see FIG. 5) determines that the fed sheet is the processable sheet Sa when the detection information of the optical sensor 220, that is, the intensity of the reflected light, is less than a first threshold value and the detection information of the thickness detection section 224, that is, the intensity of the reception signal, exceeds a second threshold value. Accordingly, for example, glossy paper having a large thickness and a high glossiness is determined as the non-processable sheet Sb, and plain paper having a small thickness and a low glossiness is determined as the processable sheet Sa.

Since the criterion for determining whether or not the sheet is the processable sheet Sa differs depending on the sheet manufacturing device 5, the above-described determination criterion is an example and is not a limitation. For example, it may be determined whether the fed sheet is the processable sheet Sa by using either the optical sensor 220 or the thickness detection section 224.

Although a non-contact type ultrasonic sensor is used as the thickness detection section 224 in the present embodiment, the thickness detection section is not limited to this and, for example, a contact type thickness detection sensor may be used.

Next, a transport roller pair 205 is provided downstream of the thickness detection section 224, and a flap 212 is provided further downstream thereof. The sheet transport path downstream of the flap 212 branches into a first transport path T1 and a second transport path T2.

Note that in the following, the term "roller pair" is assumed to be configured of a drive roller driven by a power source such as a motor and a driven roller that is in contact with the drive roller and rotates in a driven manner, unless otherwise specifically described.

The flap 212 switches the transport destination of the sheet to either the first transport path T1 or the second transport path T2 under the control of the management section 480 (see FIG. 5). The management section 480 sets the transport destination of the processable sheet Sa to the first transport path T1, and sets the transport destination of the non-processable sheet Sb to the second transport path T2.

The second transport path T2 is curved downward and has a shape in which the transport direction is inverted. Transport roller pairs 207, 208, 209, and 210 are provided on the second transport path T2, and the non-processable sheet Sb is discharged to the discharge tray 213 by these transport roller pairs.

In this way, the sorting device 2 includes the discharge tray 213 as a discharge section for discharging the non-processable sheet Sb, which is unsuitable for recycling in the sheet manufacturing device 5, so that the user can bring back the non-processable sheet Sb, which is unsuitable for recycling in the sheet manufacturing device 5, thereby improving usability.

Instead of discharging the non-processable sheet Sb to the discharge tray 213, the non-processable sheet Sb may be shredded by a shredder from the viewpoint of security protection. In this case, a dedicated shredder may be provided, or a coarse shredding section 303 (to be described later) may be used. In a case where the coarse shredding section 303 (to be described later) is used, it is preferable to provide a dedicated portion for storing the shredded non-processable sheet Sb. In a case where an opening and closing door for accessing a portion where the shredded non-processable sheet Sb is stored is provided, the opening and closing door may be locked so that only the system administrator can access the portion.

A transport roller pair 206 is provided in the first transport path T1, and the processable sheet Sa is sent to the intake path T3 of the coarse shredding device 3 by the transport roller pair 206.

The coarse shredding device 3 has an intake path T3. A transport roller pair 301 is provided on the intake path T3, and the processable sheet Sa is sent to the coarse shredding section 303 by the transport roller pair 301.

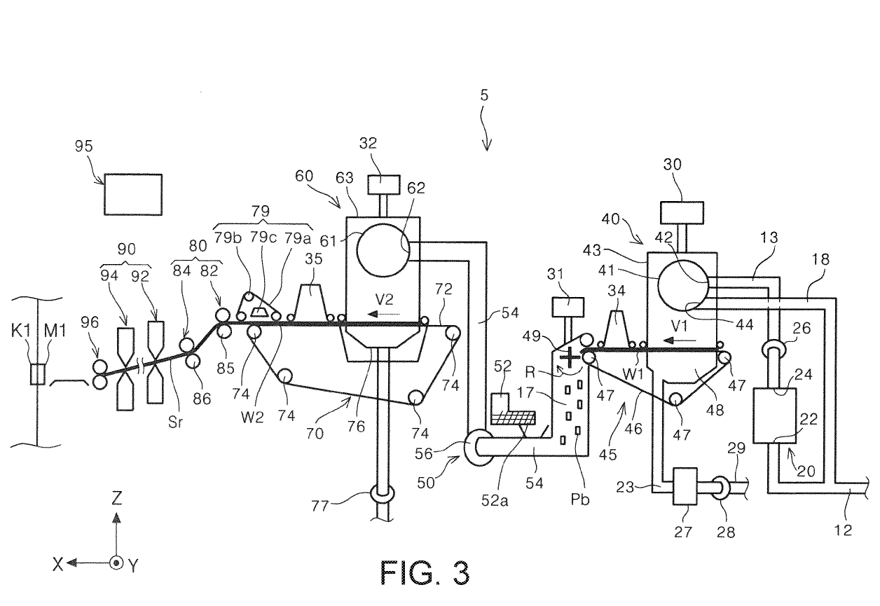

The coarse shredding section 303 shreds the processable sheet Sa into coarse fragments Pa. The coarse shredding section 303 shreds the processable sheet Sa in the air such as the atmosphere. The coarse shredding section 303 may have a configuration similar to that of a so-called shredder that pinches and shreds the processable sheet Sa, for example. The shape and size of the coarse fragments Pa are arbitrary, and need only be suitable for the defibrating process in the defibration section 20 (see FIG. 3) of the sheet manufacturing device 5 (to be described later). The coarse shredding section 303 shreds the processable sheet Sa into coarse fragments Pa having a size of, for example, 1 cm to several cm square or less.

The coarse fragments Pa are deposited on the bottom section of a chute 302. Note that a humidification section (not illustrated) may be provided in the chute 302 to humidify the coarse fragments Pa, thereby suppressing adhesion of the raw material due to static electricity.

A weight detection section 307 is provided at the bottom section of the chute 302, and can measure the weight of the accumulated coarse fragments Pa. The management section 480 (see FIG. 5) can receive the detection information of the weight detection section 307.

A fan 305 controlled by the management section 480 is provided at the bottom section of the chute 302. The fan 305 is rotated by the power of a motor (not illustrated) to send the accumulated coarse fragments Pa to the tube 12.

As an example, the management section 480 drives the fan 305 after measuring the weight of the coarse fragments Pa. For example, when the management section 480 determines that there is no sheet on the feed tray 201 and all the processable sheets Sa are coarsely shredded, the management section 480 acquires the total weight of the coarse fragments Pa and then drives the fan 305.

The coarse shredding device 3 described above may be integrally configured with the sorting device 2 and function as a part of the sorting device 2, or may be integrally configured with the sheet manufacturing device 5 and function as a part of the sheet manufacturing device 5. Similarly, the sorting device 2 may be configured integrally with the sheet manufacturing device 5 together with the coarse shredding device 3, and may function as a part of the sheet manufacturing device 5.

### Configuration of Sheet Manufacturing Device

Next, the configuration of the sheet manufacturing device 5 will be described with reference to FIG. 3.

The sheet manufacturing device 5 is a device that uses the processable sheet Sa, which has been shredded into the coarse fragments Pa, as a raw material, and manufactures the recycled sheet Sr by defibrating the raw material into fibers in a dry manner, and then compressing, heating, and cutting the fibers. Various additives may be mixed with the fiberized raw material to improve the bonding strength and whiteness of the recycled sheet Sr or to add properties such as color, fragrance, and flame retardancy according to the application. By forming the recycled sheet Sr with the densities, thicknesses, and shapes thereof controlled, it is possible to manufacture the recycled sheets Sr of various thicknesses and sizes, such as A4 size and A3 size paper, and name card paper, in accordance with the intended use.

The sheet manufacturing device 5 includes a defibration section 20, a sorting section 40, a first web forming section 45, a rotary body 49, a mixing section 50, a deposition section 60, a transport section 79, a sheet forming section 80, and a cutting section 90.

The sheet manufacturing device 5 further includes a control section 95 that controls each component or the like described above. The control section 95 can communicate with the management section 480 (to be described later), and controls each unit of the sheet manufacturing device 5 based on the control of the management section 480. The control section 95 includes a CPU, a memory, a control circuit, an I/F (none of which are illustrated), and the like. I/F is an abbreviation for interface. The CPU is a calculation processing device. The memory is a storage device that secures a region for storing various programs, CPU parameters, work areas, and the like, and includes storage elements such as RAM and EEPROM or the like. The I/F is configured to transmit and receive information to and from an external device, such as an information processing terminal. The control section 95 controls each drive section and the like via the control circuit by executing calculation processes in the CPU according to various programs and the like.

The sheet manufacturing device 5 also includes humidification sections 30, 31, 32, 34, and 35 for humidifying the raw material and the space through which the raw material moves. The humidification suppresses adhesion of the raw material due to static electricity. The humidification sections 30, 31, and 32 are configured by, for example, a vaporization type or a warm air vaporization type humidifier. The humidification sections 34 and 35 are configured by, for example, ultrasonic type humidifiers.

The coarse fragments Pa supplied from the coarse shredding device 3 to the tube 12 are transported to the defibration section 20.

The defibration section 20 performs a defibrating process on the coarse fragments Pa to generate defibrated material. Here, "defibrating" means unraveling a raw material, in which plural fibers are bound, into individual fibers. The defibration section 20 has a function of separating substances such as resin particles, ink, toner, and a bleeding inhibitor attached to the raw material from the fibers.

The material that has passed through the defibration section 20 is hereinafter referred to as defibrated material. In addition to the unraveled defibrated fibers, the defibrated material may contain resin particles separated from the fibers when unraveling the fibers, that is, resin particles for binding a plurality of fibers, a color material such as ink or toner, and additives such as a bleeding inhibitor or a paper strengthening agent.

The defibration section 20 performs dry defibrating. Here, performing a process such as defibrating in a gas such as the atmosphere, not in a liquid, is referred to as a dry process. The defibration section 20 includes, for example, an impeller mill (not illustrated), a rotor (not illustrated) that rotates at a high speed, and a liner (not illustrated) disposed on the outer circumference of the rotor. The coarse fragments Pa are defibrated by being held between the rotor and the liner of the defibration section 20. The defibration section 20 generates an airflow by the rotation of the rotor. The defibration section 20 can suck the coarse fragments Pa, which are the raw material, from the tube 12 via the inlet 22 by the airflow, and transport the defibrated material to the outlet 24. The defibrated material is sent out from the outlet 24 to the tube 13 and is transported to the sorting section 40 via the tube 13. In the present embodiment, the sheet manufacturing device 5 includes a defibration blower 26, which is an airflow generation device, and the defibrated material is transported to the sorting section 40 by the airflow generated by the defibration blower 26.

The sorting section 40 is provided with an inlet 42 into which the defibrated material defibrated by the defibration section 20 flows from the tube 13 together with the airflow. The sorting section 40 screens the defibrated material introduced from the inlet 42 according to the length of the fibers. Specifically, the sorting section 40 screens the defibrated material defibrated by the defibration section 20, with the defibrated material having a predetermined size or less as a first screened material and the defibrated material larger than the first screened material as a second screened material. The first screened material includes fibers, particles, or the like, and the second screened material includes, for example, large fibers, undefibrated pieces, coarse fragments that are not sufficiently defibrated, lumps in which defibrated fibers are aggregated or entangled, or the like.

The sorting section 40 includes, for example, a drum section 41 and a housing section 43 configured to house the drum section 41.

The drum section 41 is a cylindrical sieve that is configured to be rotationally driven by a motor. The drum section 41 has a net and functions as a sieve. The drum section 41 sorts the defibrated material into a first screened material smaller than the mesh size and a second screened material larger than the mesh size. As the mesh of the drum section 41, for example, a wire mesh, an expanded metal obtained by stretching a metal plate that has small cuts, or punched metal obtained by forming holes in a metal plate with a press machine or the like can be used.

The defibrated material introduced from the inlet 42 is sent into the drum section 41 together with the airflow, and the first screened material falls downward from the mesh of the net of the drum section 41 by the rotation of the drum section 41. The second screened material that cannot pass through the mesh of the net of the drum section 41 is caused to flow by airflow introduced into the drum section 41 from the inlet 42, is guided toward the outlet 44, and is sent out to the tube 18. The tube 18 connects the inside of the drum section 41 and the tube 12. The second screened material flowing through the tube 18 is returned to the defibration section 20 and subjected to the defibrating process.

The first screened material sorted by the drum section 41 passes through the mesh of the net of the drum section 41, disperses in the air, and descends toward the mesh belt 46 of the first web forming section 45 positioned below the drum section 41.

The first web forming section 45 includes a mesh belt 46, a roller 47, and a suction section 48. The mesh belt 46 is an endless belt, is bridged between three rollers 47, and is rotationally moved by the rotation of the rollers 47. The surface of the mesh belt 46 is formed of a net in which openings of a predetermined size are arranged. Of the first screened material falling from the sorting section 40, fine particles of a size that passes through the mesh of the net fall below the mesh belt 46, and fiber of a size that cannot pass through the mesh of the net is deposited on the mesh belt 46 and is transported in the direction of the arrow along with the mesh belt 46. The fine particles falling from the mesh belt 46 are relatively small or have a low density in the defibrated material, that is, the first screened material, that is, the fine particles include resin particles, coloring material, additives, and the like which are not necessary for binding between fibers, and are removed as materials not used by the sheet manufacturing device 5 for manufacturing the recycled sheet Sr.

The mesh belt 46 moves at a constant speed V1 during the normal operation of manufacturing the recycled sheet Sr. Here, the term “normal operation” refers to operations excluding the periods during which the start-up control or shutdown control of the sheet manufacturing device 5 is being executed, and, more specifically, refers to the period during which the sheet manufacturing device 5 is producing the recycled sheet Sr with the desired quality.

The suction section 48 sucks air from below the mesh belt 46. The suction section 48 is connected to the dust collection section 27 via the tube 23. The dust collection section 27 is a filter type or cyclone type dust collection device, and separates fine particles from the airflow. A collection blower 28 is installed downstream of the dust collection section 27, and the collection blower 28 functions as a suction section for dust collection that sucks air from the dust collection section 27. The air discharged by the collection blower 28 is discharged to the outside of the sheet manufacturing device 5 through a tube 29.

In the transport path of the mesh belt 46, air containing mist is supplied to the downstream of the sorting section 40 by the humidification section 34. The mist, which is fine particles of water generated by the humidification section 34, descends toward the first web W1 and supplies moisture to the first web W1. By this, the amount of moisture contained in the first web W1 is adjusted, and clinging of fibers to the mesh belt 46 due to static charge can be suppressed.

The sheet manufacturing device 5 includes a rotary body 49 configured to divide the first web W1 deposited on the mesh belt 46. The first web W1 is peeled off from the mesh belt 46 at the position where the mesh belt 46 is turned back by the roller 47, and is divided by the rotary body 49.

The rotary body 49 is formed in a rotating blade shape that includes a plate-shaped blade and is configured to rotate. The rotary body 49 is disposed at a position where the blade comes into contact with the first web W1 peeled off from the mesh belt 46. By the rotation of the rotary body 49, for example, the rotation in the direction indicated by the arrow R in the drawing, the first web W1 that is peeled off from the mesh belt 46 and transported collides with the blade and is divided, and subdivided bodies Pb are generated. The subdivided bodies Pb divided by the rotary body 49 descend inside the tube 17 and are transported to the mixing section 50 by the airflow flowing inside the tube 17.

The mixing section 50 includes an additive supply section 52 that supplies an additive containing a resin, a tube 54 that communicates with the tube 17 and through which an airflow containing the subdivided bodies Pb flows, and a mixing blower 56. The mixing section 50 mixes an additive including resin with the fibers constituting the subdivided bodies Pb.

In the mixing section 50, an airflow is generated by the mixing blower 56, and the subdivided bodies Pb and the additive are transported while being mixed in the tube 54. The subdivided bodies Pb are loosened in the process of flowing through the tube 17 and the tube 54 and become finer fibrous.

The additive supply section 52 is connected to an additive cartridge (not illustrated) that stores the additive and supplies the additive from the additive cartridge to the tube 54. The additive supply section 52 stores the additive made of fine powder or fine particles inside the additive cartridge. The additive supply section 52 includes a discharge section 52a that supplies the stored additive to the tube 54.

The additive supplied by the additive supply section 52 includes a resin for binding a plurality of fibers. The resin contained in the additive is a thermoplastic resin or a thermosetting resin, and examples thereof include an AS resin, an ABS resin, polypropylene, polyethylene, polyvinyl chloride, polystyrene, an acrylic resin, a polyester resin, polyethylene terephthalate, polyphenylene ether, polybutylene terephthalate, polyamide, polycarbonate, polyacetal, polyphenylene sulfide, polyether ether ketone, and the like. These resins may be used alone or in combination. That is, the additive may include a single substance, may be a mixture, or may include a plurality of types of particles, each formed of a single substance or a plurality of substances. The additive may be in the form of fibers or powder.

The resin contained in the additive is melted by heating and binds the plurality of fibers to each other. Therefore, in a state where the resin is mixed with the fibers and the resin is not heated to a temperature at which the resin is melted, the fibers are not bonded to each other.

The subdivided bodies Pb descending through the tube 17 and the additive supplied by the additive supply section 52 are sucked into the tube 54 by the airflow generated by the mixing blower 56 and pass through the inside of the mixing blower 56. The fibers constituting the subdivided bodies Pb and the additive are mixed by the airflow generated by the mixing blower 56 and by the action of a rotary section including a blade of the mixing blower 56, and a mixture, that is, the mixture of the first screened material and the additive, is transported to the deposition section 60 through the tube 54.

The deposition section 60 includes a second web forming section 70, introduces the mixture of the first screened material and the additive that has passed through the mixing section 50 from an inlet 62, loosens the entangled defibrated material that is first screened material, and causes the first screened material to fall while dispersing it in the air. In a case where the resin of the additive supplied from the additive supply section 52 is fibrous, the deposition section 60 unravels the entangled resin. By this, the deposition section 60 can thereby deposit the mixture uniformly on the second web forming section 70.

The deposition section 60 includes a drum section 61 and a housing section 63 that houses the drum section 61. The drum section 61 is a cylindrical sieve that is driven to rotate by a motor. The drum section 61 has a net and functions as a sieve. The drum section 61 allows fibers and particles having a smaller size than the mesh size to pass through the mesh of the net and to descend from the drum section 61. The configuration of the drum section 61 is the same as the configuration of the drum section 41, for example.

The second web forming section 70 is disposed below the drum section 61. The second web forming section 70 deposits the material that passed through the deposition section 60 so as to form a second web W2. The second web forming section 70 includes, for example, a mesh belt 72, a roller 74, and a suction mechanism 76.

The mesh belt 72 is an endless belt, is bridged between a plurality of rollers 74, and is rotationally moved by the movement of the rollers 74. The mesh belt 72 is, for example, made of metal, resin, cloth, or non-woven fabric. The surface of the mesh belt 72 is formed of a net in which openings of a predetermined size are arranged. Among the fibers and particles falling from the drum section 61, fine particles having a size that can pass through the mesh fall beneath the mesh belt 72, and fibers having a size that cannot pass through the mesh are deposited on the mesh belt 72 and are transported together with the mesh belt 72 in the direction of the arrow. The mesh belt 72 moves at a constant speed V2 during the normal operation of manufacturing the recycled sheet Sr.

The mesh of the mesh belt 72 is fine and can be set to a size so as not to allow most fibers and particles falling from the drum section 61 to pass through.

The suction mechanism 76 is provided below the mesh belt 72. The suction mechanism 76 includes a suction blower 77, and can generate a downward airflow in the suction mechanism 76 by a suction force of the suction blower 77.

The mixture dispersed in the air by the deposition section 60 is suctioned onto the mesh belt 72 by the suction mechanism 76. By this, this promotes the formation of the second web W2 on the mesh belt 72, and increases the discharge speed from the deposition section 60. Furthermore, a downflow can be formed in the falling path of the mixture by the suction mechanism 76, and the defibrated material and the additive can be prevented from becoming entangled during falling.

As described above, the second web W2 in a soft and swollen state containing a large amount of air is formed through the deposition section 60. The second web W2 deposited on the mesh belt 72 is transported to the sheet forming section 80.

In the transport path of the mesh belt 72, air containing mist is supplied to the downstream of the deposition section 60 by the humidification section 35. By this, the mist generated by the humidification section 35 is supplied to the second web W2, and the amount of moisture contained in the second web W2 is adjusted. By this, clinging and the like of the fibers to the mesh belt 72 due to static electricity can be suppressed.

The sheet manufacturing device 5 includes a transport section 79 that transports the second web W2, which is on the mesh belt 72, to the sheet forming section 80. The transport section 79 includes, for example, a mesh belt 79a, a roller 79b, and a suction mechanism 79c.

The suction mechanism 79c includes a blower (not illustrated), and generates an upward airflow at the mesh belt 79a by the suction force of the blower. This airflow draws the second web W2, and the second web W2 separates from the mesh belt 72 and clings to the mesh belt 79a.

The mesh belt 79a moves by the rotation of the roller 79b, and transports the second web W2 to the sheet forming section 80.

In this manner, the transport section 79 peels off the second web W2 formed on the mesh belt 72 from the mesh belt 72 and transports the second web W2.

The sheet forming section 80 forms the recycled sheet Sr by performing at least either heat or compression on the second web W2. The sheet forming section 80 of the present embodiment forms the recycled sheet Sr by pressurizing and heating the second web W2 that is deposited on the mesh belt 72 and transported by the transport section 79. The sheet forming section 80 applies heat to the fibers and additives contained in the second web W2 to bind the plurality of fibers in the mixture to one another via the resin.

The sheet forming section 80 includes a pressurizing section 82 that presses the second web W2, and a heating section 84 that heats the second web W2 after being pressed by the pressurizing section 82.

The pressurizing section 82 is configured by a pair of calender rollers 85, and presses the second web W2 by sandwiching the second web W2 with a predetermined nip pressure. The second web W2 is reduced in thickness by being pressed, and the second web W2 is densified. One roller of the pair of calender rollers 85 serves as a drive roller and is driven by a motor (not illustrated), while the other serves as a driven roller. The calender roller 85 is rotated by the driving force of the motor, and transports the second web W2, which has become highly dense due to the pressing, toward the heating section 84.

The heating section 84 is configured by, for example, a heated roller, a hot press molding machine, a hot plate, a hot air blower, an infrared heater, a flash fixing device, or the like. In the present embodiment, the heating section 84 includes a pair of heated rollers 86. The heated rollers 86 are heated to a preset temperature by a heater installed inside or outside the heated rollers 86. The heated rollers 86 sandwich and heat the second web W2 pressed by the calender rollers 85 to form the recycled sheet Sr.

One roller of the pair of heated rollers 86 serves as a drive roller and is driven by a motor (not illustrated), while the other serves as a driven roller. The heated rollers 86 are rotated by the driving force of the motor and transport the heated recycled sheet Sr toward the cutting section 90.

The cutting section 90 cuts the recycled sheet Sr formed by the sheet forming section 80 to a predetermined length. The cutting section 90 of the present embodiment includes a first cutting section 92 that cuts the recycled sheet Sr in a direction that intersects the transport direction of the recycled sheet Sr and a second cutting section 94 that cuts the recycled sheet Sr in a direction parallel to the transport direction. The second cutting section 94 cuts, for example, the recycled sheet Sr that has passed through the first cutting section 92. By this, a cut form sheet type recycled sheet Sr of a predetermined size is formed.

The cut form sheet type recycled sheet Sr receives a sending force from a feed roller pair 96, is discharged from the discharge port M1 to the intake section K1 of the printing device 7, and enters the printing device 7 from the intake section K1. The feed roller pair 96 functions as a supply section for supplying the recycled sheet Sr from the sheet manufacturing device 5 to the printing device 7.

### Configuration of Printing Device

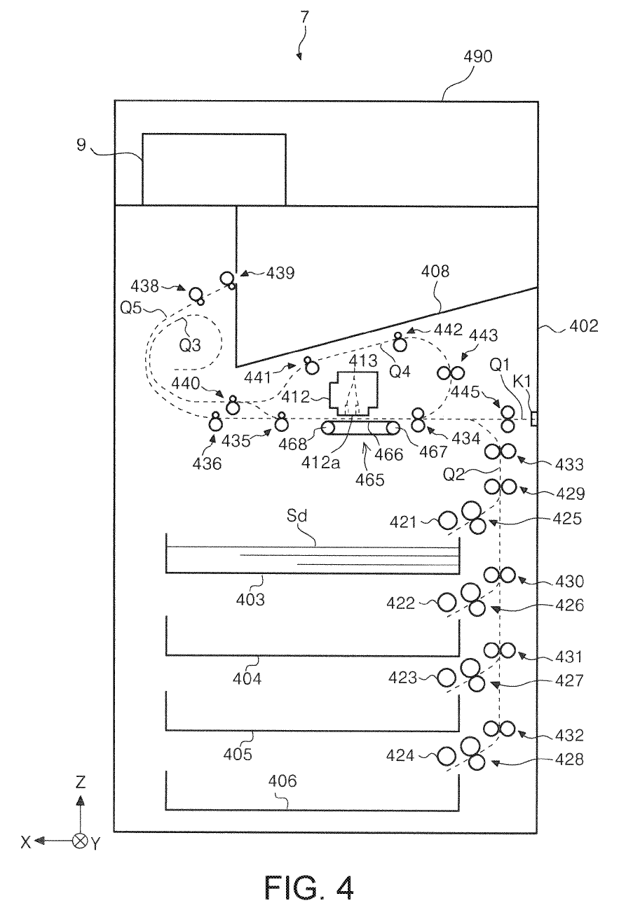

Next, the configuration of the printing device 7 will be described with reference to FIG. 4.

In the present embodiment, the printing device 7 is an inkjet printer that performs recording by ejecting ink, which is an example of a liquid, onto the recycled sheet Sr or the non-manufactured sheet Sd, which are examples of medium.

The printing device 7 includes a plurality of sheet cassettes, specifically, a first sheet cassette 403, a second sheet cassette 404, a third sheet cassette 405, and a fourth sheet cassette 406 along the vertical direction in a lower portion of an device main body 402 including a liquid ejection section 412 (to be described later). Hereinafter, when these sheet cassettes are not distinguished from each other, they are simply referred to as a sheet cassette. In FIG. 4, the non-manufactured sheet Sd is stored in the first sheet cassette 403 as an example.

A pickup roller that feeds out the stored sheet in the -X direction is provided for each sheet cassette. Reference numerals 421, 422, 423, and 424 denote pickup rollers provided for the respective sheet cassettes.

A feed roller pair, which feeds the sheet that was fed by the pickup roller further downstream, is provided for each sheet cassette. Reference numerals 425, 426, 427, and 428 denote feed roller pairs provided for the respective sheet cassettes.

The sheet fed from the first sheet cassette 403 is fed to a transport roller pair 434 by receiving a sending force from transport roller pairs 429 and 433. The sheet fed from the second sheet cassette 404 is fed to the transport roller pair 434 by receiving a sending force from a transport roller pair 430 and from the transport roller pairs 429 and 433. The sheet fed from the third sheet cassette 405 is fed to the transport roller pair 434 by receiving a sending force from a transport roller pair 431 and from the transport roller pairs 430, 429, and 433. The sheet fed from the fourth sheet cassette 406 is fed to the transport roller pair 434 by receiving a sending force from a transport roller pair 432 and from the transport roller pairs 431, 430, 429, and 433. Reference numeral Q2 indicates a transport path of a sheet fed from each sheet cassette to the transport roller pair 434.

The medium receiving the sending force from the transport roller pair 434 is sent between the liquid ejection section 412 and the transport belt 466, namely to a liquid ejecting position facing the liquid ejection section 412.

The liquid ejection section 412 ejects liquid onto a surface of a sheet. In the present embodiment, the liquid ejection section 412 is a line head in which a plurality of nozzles 413 for ejecting liquid are arranged over the entire region in the sheet width direction. However, the liquid ejection section 412 may be an ink ejection head mounted on a carriage and configured to eject liquid while moving in the sheet width direction.

The transport belt 466 is an endless belt bridged with a drive roller 467 and a driven roller 468, and rotates when the drive roller 467 is driven by a motor (not illustrated). The sheet is transported to a position facing the liquid ejection section 412 while being attracted to the belt surface of the transport belt 466. The drive roller 467, the driven roller 468, and the transport belt 466 constitute a belt unit 465.

The sheet onto which the liquid has been ejected by the liquid ejection section 412 is sent toward either a transport roller pair 436 or a transport roller pair 440 by a transport roller pair 435 located downstream of the transport belt 466. Accordingly, a path switching flap (not illustrated) is provided in the vicinity downstream of the transport roller pair 435.

In a case where the surface of the sheet is inverted and the liquid is not ejected to the sheet again, the sheet is sent from the transport roller pair 435 toward the transport roller pair 436. A discharge path Q5 is provided downstream from the transport roller pair 436.

The sheet fed to the discharge path Q5 is curved and inverted and discharged to the discharge tray 408. A transport roller pair 438 and a transport roller pair 439 are provided on the discharge path Q5.

In a case where the surface of the sheet is inverted and the liquid is ejected to the sheet again, the sheet is fed from the transport roller pair 435 toward the transport roller pair 440 and enters the switchback path Q3. Thereafter, the rotation direction of the transport roller pair 440 is switched, the sheet is switched back and enters the inversion path Q4, and is sent to the transport roller pair 434 by transport roller pairs 441, 442, and 443.

The printing device 7 includes an intake section K1 that receives the recycled sheet Sr from the sheet manufacturing device 5 on a side face in the -X direction.

The recycled sheet Sr received from the intake section K1 is sent to the transport roller pair 434 by a transport roller pair 445. The reference numeral Q1 denotes a transport path along which the recycled sheet Sr received from the intake section K1 is transported.

The printing device 7 includes a liquid container configured to store liquid to be ejected from the liquid ejection section 412, and similar components (not illustrated).

Although detailed illustration and description are omitted, the printing device 7 includes a scanner section 490 as an image reading device on an upper portion of the device main body 402. The scanner section 490 includes a reading section (not illustrated) and a document transport section (not illustrated). Accordingly, the printing device 7 can read a document using the scanner section 490 and print the read content using the liquid ejection section 412, that is, copy the document.

### Configuration of Management Section

Hereinafter, the configuration of the management section 480 will be described with reference to FIG. 5. FIG. 5 is a block diagram illustrating the configuration of the management section 480 mainly from the hardware viewpoint, and shows a part expressed from a functional viewpoint.

The management section 480 performs various controls in the sheet recycling system 1. Note that FIG. 5 mainly illustrates a configuration necessary for the following description, the illustrations of other configurations are omitted.

In the present embodiment, the management section 480 is arranged in the printing device 7, and serves also as a control section that performs various controls of the printing device 7. However, the management section 480 may be provided in any of other devices constituting the sheet recycling system 1, for example, the sorting device 2, the coarse shredding device 3, the sheet manufacturing device 5, and the payment device 8, or may be provided as an independent single device, for example, a server device.

The management section 480 controls the sorting device 2, the coarse shredding device 3, the sheet manufacturing device 5, the printing device 7, and the payment device 8.

The management section 480 includes a CPU 481 that executes a computer program, that is, software, a volatile memory 482, and a non-volatile memory 483. The CPU 481 performs various calculations necessary for executing a program 484 stored in the non-volatile memory 483. The volatile memory 482 is used as a temporary data storage region. The non-volatile memory 483 stores the program 484 and a control parameter 485 that is necessary for executing the program 484. The program 484 includes a program for executing various processes (to be described later) and the control parameter 485 includes a parameter for executing the program 484. Various processes (to be described later) are implemented by the management section 480 executing the program 484.

The management section 480 can receive various operation settings by the user from the operation panel 9 included in the printing device 7. The operation panel 9 includes a touch panel, a power button, and other setting buttons (not illustrated). The touch panel (not illustrated) implements various user interfaces (hereinafter referred to as "UIs") for using the sheet recycling system 1. In the present embodiment, the operation panel 9 is provided in the printing device 7, but the present disclosure is not limited to this, and the operation panel 9 may be provided in any one of the sorting device 2, the coarse shredding device 3, the sheet manufacturing device 5, and the payment device 8, or may be provided as an independent single device.

The management section 480 includes a billing amount calculation section 492 as a functional unit. The billing amount calculation section 492 is a software module implemented by executing the program 484. The function of the billing amount calculation section 492 will be described later.

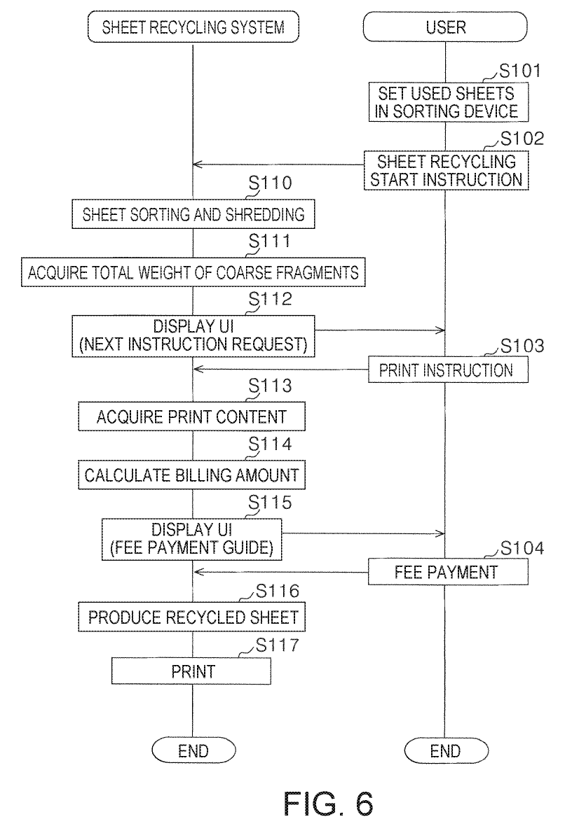

Next, an operation performed by the user and a flow of processing in the sheet recycling system 1 will be described with reference to FIG. 6.

First, the user sets a used sheet in the sorting device 2 (step S101). Then, the user issues a sheet recycling start instruction via the UI (not illustrated) of the operation panel 9 (step S102).

In response to this, the management section 480 controls the sorting device 2 and the coarse shredding device 3 to sort and shred the sheet (step S110). Next, the management section 480 acquires the total weight of the coarse fragments Pa (step S111). The information indicating the total weight of the coarse fragments Pa is an example of second information related to the amount of the processable sheets Sa. The weight detection section 307 of the coarse shredding device 3 transmits the second information to the management section 480.

Next, the management section 480 displays a UI (not illustrated) for requesting the next instruction on the operation panel 9 (step S112). Here, an instruction that can be selected by the user is, for example, either a print instruction or a cancel instruction. In FIG. 6, it is assumed that the user selects the print instruction. Examples of the print instruction include a copy instruction and a print instruction for content downloaded via the Internet.

When the user selects the print instruction (step S103), the management section 480 acquires the print content (step S113). The print content includes a sheet type, a sheet size, the number of sheets to be printed, contents of printing, and the like. The information indicating the print content is an example of first information related to print content when printing is performed using the printing device 7. The sheet types include the recycled sheet Sr and the non-manufactured sheet Sd, and the user can select one of these sheets via a UI (not illustrated) to configure print settings. In the flow of FIG. 6, it is assumed that the recycled sheet Sr is selected.

Then, the management section 480 calculates the billing amount (step S114). The information related to the billing amount calculated in step S114 is an example of third information generated based on the first information and the second information. Details of a method of calculating the billing amount will be described later.

Then, the management section 480 causes the operation panel 9 to display a UI (not illustrated) for guiding the payment of the fee (step S115). The UI displays the billing amount.

When the user receives this and pays the fee using the payment device 8 (step S104), the management section 480 controls the sheet manufacturing device 5 to manufacture the recycled sheet Sr (step S116). The management section 480 then feeds the manufactured recycled sheet Sr from the sheet manufacturing device 5 to the printing device 7, and executes printing (step S117).

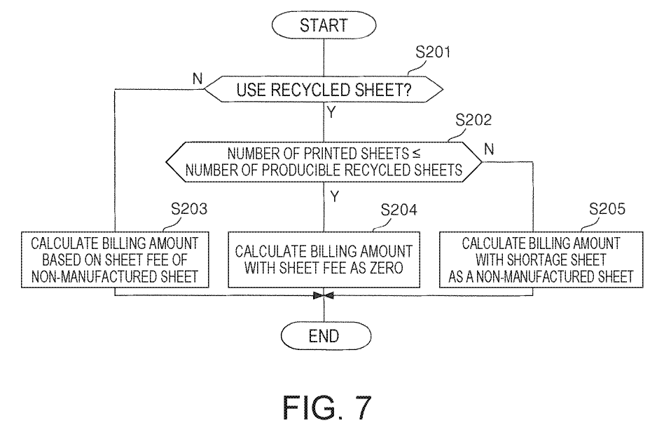

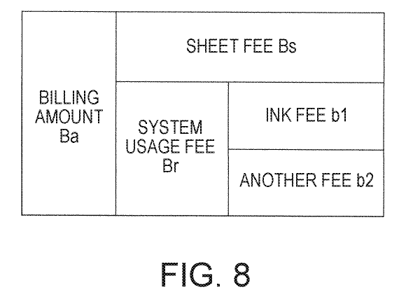

Next, a method of calculating the billing amount will be described with reference to FIGS. 7 and 8. Hereinafter, a billing amount calculated in step S114, that is, the billing amount presented to the user is denoted by reference numeral Ba and referred to as a billing amount Ba. Hereinafter, first, the breakdown of the billing amount Ba will be described with reference to FIG. 8.

In the present embodiment, the billing amount Ba includes a sheet fee Bs and a system usage fee Br. For example, if printing is performed using only the non-manufactured sheet Sd without using the recycled sheets Sr, the sheet fee Bs is an amount obtained by multiplying the unit cost of the non-manufactured sheet Sd by the number of printed sheets. The sheet fee Bs is zero, for example, if all the number of printed sheets is covered by the recycled sheet Sr. The unit cost of the non-manufactured sheet Sd is set for each sheet size and included in the control parameter 485 (see FIG. 5).

The system usage fee Br includes, for example, an ink fee according to the content of printing, that is, an ink fee b1 according to an ink ejection amount, and another fee b2 charged in consideration of running costs of the sheet recycling system 1, and the system usage fee Br is obtained by adding these. The ink fee b1 can be calculated based on the print data. Another fee b2 can be obtained by multiplying a predetermined unit cost per print page by the number of print pages, for example. The ink fee b1 and other information necessary for calculating the other fee b2 are included in the control parameter 485 (see FIG. 5.) The system usage fee Br may be set to zero, another fee b2 may be set to zero so that the system usage fee Br consists only of the ink fee b1, or the system usage fee Br may be set in another manner.

In the above-described billing amount calculation method, the billing amount calculation section 492 in FIG. 7 determines whether the print content when printing is performed using the printing device 7 is to use the recycled sheet Sr (step S201.) When the print content for printing using the printing device 7 involves the use of the recycled sheet Sr (Yes in step S201), the billing amount calculation section 492 determines whether the number of sheets to be printed is equal to or less than the number of recycled sheets Sr that can be produced (step S202).

Here, the billing amount calculation section 492 calculates the number of producible recycled sheets Sr. The sheet size included in the print content is taken into account in this calculation. For example, when the print content is to print on a sheet of A4 size, the billing amount calculation section 492 determines how many recycled sheets Sr of A4 size can be manufactured based on the total weight of the coarse fragments Pa. Information relating to the weight of the coarse fragments Pa necessary for manufacturing one recycled sheet Sr of a predetermined size is included in the control parameter 485 (refer to FIG. 5.)

Then, when the number of printed sheets is equal to or less than the number of sheets that can be produced from the recycled sheet Sr (Yes in Step S202), the billing amount calculation section 492 calculates the billing amount Ba by setting the sheet fee Bs to zero (Step S204). Therefore, the billing amount Ba in this case is only the system usage fee Br.

In the case of No in step S202, that is, in the case where the number of sheets to be printed exceeds the number of recycled sheets Sr that can be produced, there are insufficient recycled sheets Sr. Therefore, in this case, as an example, the shortage is compensated for by the non-manufactured sheets Sd. Therefore, in this case, the billing amount is calculated by using the missing sheets as the non-manufactured sheets Sd (step S205). That is, the billing amount Ba in this case is: the sheet fee Bs for the shortage + the system usage fee Br.

In the case of No in step S201, that is, in the case where the print contents when printing is performed using the printing device 7 are all print contents for performing printing using the non-manufactured sheet Sd, the billing amount is calculated based on the fee of the non-manufactured sheet Sd (step S203). That is, the billing amount Ba in this case is: the sheet fee Bs + the system usage fee Br. The billing amount Ba in this case may be discounted based on the total weight of the coarse fragments Pa. In this case, the billing amount calculation section 492 calculates the fee of the coarse fragments Pa based on the total weight of the coarse fragments Pa. The information relating to the fee per unit weight of the coarse fragments Pa is included in the control parameter 485 (refer to FIG. 5).

Hereinafter, the operations and effects of the present embodiment described above will be described.

The sheet recycling system 1 according to the present embodiment includes at least a sheet manufacturing device 5, a printing device 7, and the management section 480.

The sheet manufacturing device 5 processes the processable sheet Sa to manufacture the recycled sheet Sr. The printing device 7 can print on the recycled sheet Sr manufactured by the sheet manufacturing device 5. The management section 480 can acquire first information related to the print content when printing is performed using the printing device 7 (step S113 in FIG. 6), can acquire second information related to the amount of processable sheets Sa (step S111 in FIG. 6), and generates third information related to the billing amount based on the first information and the second information (step S114 in FIG. 6).

According to the sheet recycling system 1 or the management section 480, the user can receive a benefit in that the billing amount when printing is performed using the printing device 7 is reduced according to the amount of the processable sheets Sa. Therefore, it is possible to encourage the user to use the sheet manufacturing device 5, and it is possible to contribute to environmental protection.

Since the management section 480 generates the third information related to the billing amount based on the first information and the second information, the user can casually use the sheet recycling system 1 each time without using a complicated mechanism such as user authentication, and a system that is convenient for the user can be configured.

The frequency of replenishment of the printing device 7 with sheets by a clerk of a store in which the sheet recycling system 1 is installed is reduced, and the work efficiency is improved. Since the sheet recycling system 1 is installed in the store, a customer attracting effect can be expected.

In the present embodiment, the sheet recycling system 1 further includes the sorting device 2 that sorts the processable sheet Sa and the non-processable sheet Sb, and thus the recycled sheet Sr can be appropriately manufactured by the sheet manufacturing device 5. The user or the system administrator does not need to sort the processable sheet Sa and the non-processable sheet Sb by himself/herself, and usability is improved.

The user can set the used sheet in the sorting device 2 by himself/herself without the intervention of a clerk of the store to reproduce the sheet, and therefore, the usability is good.

In a case where the sheet recycling system 1 does not include the sorting device 2, the sorting of the processable sheet Sa and the non-processable sheet Sb may be performed by the user or the clerk of the store according to a predetermined determination criterion.

In a case where the sheet recycling system 1 does not include the sorting device 2, the processable sheet Sa and the non-processable sheet Sb may be mixed in the used sheet which is input to the coarse shredding device 3.

In this case, there is a concern that a problem such as a decrease in the whiteness of the recycled sheet Sr may occur, but the sheet recycling system 1 can be operated within a range in which a failure of the sheet manufacturing device 5 does not occur. In this case, the weight of the coarse fragments Pa may include the weight of the non-processable sheet Sb.

In the sheet recycling system 1 according to the present embodiment, the printing device 7 can accommodate the non-manufactured sheet Sd that is not manufactured by the sheet manufacturing device 5 and can selectively feed the recycled sheet Sr and the non-manufactured sheet Sd, and thus, it is possible to select a sheet to be used for printing according to the preference of the user, and usability is improved.

In the present embodiment, since the feed roller pair 96 that supplies the recycled sheet Sr from the sheet manufacturing device 5 to the printing device 7 is provided, it is not necessary for a user or a system administrator to set the recycled sheet Sr in the printing device 7 by himself/herself, and usability is improved.

In a case where the number of recycled sheets Sr that can be manufactured by the sheet manufacturing device 5 is equal to or greater than the number of sheets required for printing using the printing device 7 (Yes in step S202 of FIG. 7), the billing amount calculation section 492 according to the present embodiment sets at least the sheet fee included in the billing amount Ba to zero (step S204 of FIG. 7). By this, this can encourage the user to use the sheet manufacturing device 5, and contribute to environmental protection.

When the number of recycled sheets Sr that can be manufactured by the sheet manufacturing device 5 exceeds the number of sheets required for printing using the printing device 7 (Yes in step S202 in FIG. 7), the billing amount calculation section 492 may determine to pay money or provide a predetermined service to the user according to the number of sheets that has exceeded. In this way, it is possible to further encourage the user to use the sheet manufacturing device 5 and to further contribute to environmental protection.

Even when the number of recycled sheets Sr that can be manufactured by the sheet manufacturing device 5 exceeds the number of sheets required for printing using the printing device 7, a threshold value may be set, and payment of fee or provision of a predetermined service to the user may be determined when the threshold value is exceeded. For example, when the number of recycled sheets Sr that can be produced by the sheet manufacturing device 5 exceeds by five or more the number of sheets required for printing using the printing device 7, it may be determined that the user is to receive a monetary payment or a predetermined service. Five sheets in this case are an example of a threshold value.

Hereinafter, the excess sheets in a case where the number of the recycled sheets Sr that can be manufactured by the sheet manufacturing device 5 exceeds the number of sheets necessary for printing using the printing device 7 are referred to as excess sheets. The billing amount calculation section 492 calculates the fee of the excess sheets. The unit cost of the recycled sheet Sr is set for each sheet size and is included in the control parameter 485 (see FIG. 5.) Therefore, the billing amount calculation section 492 can calculate the fee of the excess sheets by multiplying the unit cost of the recycled sheet Sr by the number of excess sheets.

Based on the calculated fee of the excess sheets, the billing amount calculation section 492 may determine and execute rebating cash to the user via the payment device 8, or may determine and execute providing a predetermined service to the user. Examples of the predetermined services include a rebate in the form of points in a point service provided by a store in which the sheet recycling system 1 is installed, and rebates in the form of products, novelty items, or similar goods handled by the store.

The billing amount calculation section 492 according to the present embodiment sets the billing amount Ba in a case where printing is performed using the recycled sheet Sr to be lower than the billing amount Ba in a case where printing is performed using the non-manufactured sheet Sd (step S204 in FIG. 7.)

In this way, it is possible to further encourage the user to use the recycled sheet Sr and to further contribute to environmental protection.

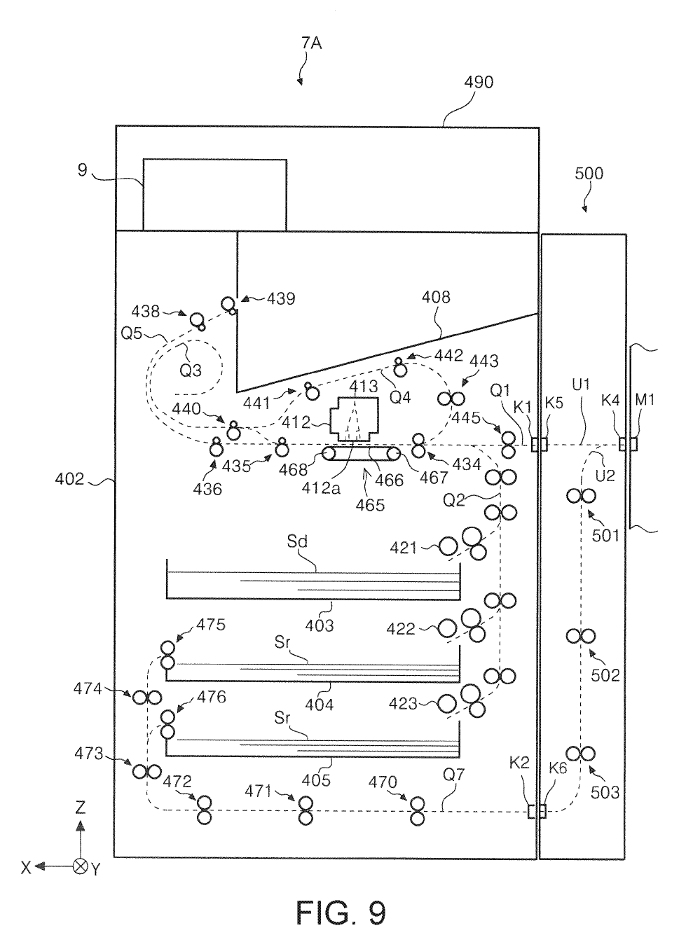

Next, a modification of the sheet recycling system 1 will be described with reference to FIG. 9. Hereinafter, the sheet recycling system according to the embodiment is denoted by reference numeral 1A. The sheet recycling system 1A includes the printing device 7A, and a relay device 500 between the sheet manufacturing device 5 and the printing device 7A. In FIG. 9, the same reference numerals are given to the same components as those of the printing device 7 described above, and the description thereof will not be repeated. In FIG. 9, for convenience of illustration, some reference numerals are omitted.

The relay device 500 also functions as a supply section that supplies the recycled sheet Sr from the sheet manufacturing device 5 to the printing device 7A.

First, the printing device 7A includes a intake section K2 in addition to the intake section K1 as a portion that receives the recycled sheet Sr. The intake section K2 is provided in a lower portion of the device main body 402. The recycled sheet Sr received from the intake section K2 is transported by the transport path Q7. Transport roller pairs 470, 471, 472, 473, and 474 are provided in the transport path Q7.

A switching flap (not illustrated) controlled by the management section 480 is provided between the transport roller pair 473 and the transport roller pair 474, and the transport destination of the recycled sheet Sr can be switched to either the transport roller pair 474 or a transport roller pair 476. When the transport destination of the recycled sheet Sr is set to the transport roller pair 476, the recycled sheet Sr is stored in the third sheet cassette 405 by the transport roller pair 476.

When the transport destination of the recycled sheet Sr is set to the transport roller pair 474, the recycled sheet Sr is stored in the second sheet cassette 404 by a transport roller pair 475.

The relay device 500 has an intake section K4 that receives the recycled sheet Sr from the sheet manufacturing device 5. A switching flap (not illustrated) controlled by the management section 480 is provided in the vicinity of the intake section K4, and the transport destination of the recycled sheet Sr can be switched to either the transport path U1 or the transport path U2. The transport path U1 is a path for transporting the recycled sheet Sr to the discharge port K5. The discharge port K5 faces the intake section K1 of the printing device 7A.

Transport roller pairs 501, 502, and 503 are provided in the transport path U2, and the recycled sheet Sr transported in the transport path U2 is sent to the discharge port K6 by the transport roller pairs. The discharge port K6 faces the intake section K2 of the printing device 7A.

The printing device 7A is configured as described above, and the relay device 500 is provided, so that the recycled sheet Sr can be accommodated and stored in the second sheet cassette 404 or the third sheet cassette 405 of the printing device 7A. Such a configuration is suitable for a case where the recycled sheet Sr is not used for printing. For example, if the result of step S202 in FIG. 7 is YES and an excess sheets are generated, the excess sheets can be stored and kept in the printing device 7A. In the case of No in step S201, that is, in the case where the recycled sheet Sr is manufactured but is not used for printing, the recycled sheet Sr can also be accommodated and stored in the printing device 7A.

By this, for example, in the case of No in step S202 of FIG. 7, that is, in the case where there are insufficient recycled sheets Sr, the shortage can be compensated by the stored recycled sheets Sr instead of the non-manufactured sheets Sd. In many cases, the fee of the recycled sheet Sr is lower than that of the non-manufactured sheet Sd, and thus, according to the above-described configuration, the billing amount Ba in step S205 of FIG. 7 can be suppressed.

Even when the determination in step S201 of FIG. 7 is No, that is, when printing is performed on the non-manufactured sheet Sd, the recycled sheet Sr is manufactured and stored. Accordingly, the recycled sheet Sr can be effectively utilized later.

The sheet recycling system 1 according to the present embodiment is capable of manufacturing the recycled sheet Sr even when the determination in step S201 of FIG. 7 is No, that is, when printing is performed on the non-manufactured sheet Sd. In this case, the billing amount calculation section 492 may discount the billing amount Ba in step S203 of FIG. 7 based on the number of manufactured recycled sheets Sr. In this case as well, when the fee of the manufactured recycled sheet Sr exceeds the billing amount Ba, the excess amount may be rebated in cash, or, for example, may be rebated in the form of points in a point service provided by the store in which the sheet recycling system 1 is installed, or may be rebated in the form of products, novelty items, or the like handled by the store.

When the management section 480 can use user authentication, the billing amount calculation section 492 may calculate the billing amount Ba with reference to the past usage record. For example, when the user uses the sheet recycling system 1, if a rebate in cash or the like needs to be provided to the user, the management section 480 stores the rebated amount in the non-volatile memory 483 in association with the user ID. Then, the management section 480 may set the billing amount obtained by discounting the rebated amount as the billing amount Ba when the user uses the sheet recycling system 1 next time and thereafter.

The sheet recycling system 1 may have a mode in which only sheet recycling is performed without performing printing using the printing device 7. For example, in step S112 of FIG. 6, when the management section 480 causes the operation panel 9 to display a UI (not illustrated) for requesting the next instruction, the above-described modes may be selectable on the UI. In this case, the billing amount calculated based on the total weight of the coarse fragments Pa may be provided to the user as a rebate. This rebate is not limited to cash, and may be provided as a rebate in the form of points of the above-described point service, or in the form of products, novelty items, or the like handled in the store.

The present disclosure is not limited to the embodiments and modifications described above, and various changes can be made within the scope of the claims in the disclosure. It is to be understood that such changes are also included within the scope of the present disclosure.

The sheet recycling system 1 may be used in the following modes.

For example, a newspaper company, a publisher, or the like may provide a subscription service for newspapers and magazines, and a user may print and subscribe to newspapers and magazines using the printing device 7 of the sheet recycling system 1. In this usage mode, by recycling a newspaper or magazine that has been read, the user can obtain a newspaper or magazine at a low cost, which also contributes to environmental protection. The company providing the subscription service can also discount the subscription fee according to the amount of recycled paper sheet. Further, in such a case, if the company providing the subscription service can confirm that the recycled sheet corresponds to the newspaper or magazine that has been read, the company may increase the discount rate when applying the discount.

In addition to the subscription service, when the user obtains content to be printed by searching for articles, the user can obtain printed matter at a low cost by recycling printed matter that has become unnecessary, which also contributes to environmental protection.

What is claimed is:

1. A sheet recycling system comprising:
a sheet manufacturing device configured to process a processable sheet suitable for recycling into a recycled sheet;
a printing device configured to print on the recycled sheet manufactured by the sheet manufacturing device; and
a management section that is configured to acquire first information related to print content for when the printing device performs printing and second information related to an amount of the processable sheet and that is configured to generate third information related to a billing amount based on the first information and the second information.

2. The sheet recycling system according to claim 1 further comprising:
a sorting device configured to sort
processable sheets and
non-processable sheets, which are unsuitable for recycling by the sheet manufacturing device.

3. The sheet recycling system according to claim 2, wherein
when the number of recycled sheets manufacturable by the sheet manufacturing device is equal to or greater than a number of sheets required for printing by the printing device, the management section sets at least a sheet fee included in the billing amount to zero.

4. The sheet recycling system according to claim 3, wherein
when the number of recycled sheets manufacturable by the sheet manufacturing device exceeds the number required for printing by the printing device, the management section determines payment of money or provision of a predetermined service to a user according to the number of sheets exceeding the number required for printing by the printing device.

5. The sheet recycling system according to claim 2, wherein
the printing device is configured
to store a non-manufactured sheet that is not manufactured by the sheet manufacturing device and
to selectively feed the recycled sheet and the non-manufactured sheet.

6. The sheet recycling system according to claim 5, wherein
the management section sets the billing amount for printing with the recycled sheet to be lower than the billing amount for printing with the non-manufactured sheet.

7. The sheet recycling system according to claim 2, further comprising:
a supply section configured to supply the recycled sheet from the sheet manufacturing device to the printing device.

8. The sheet recycling system according to claim 2, wherein
the sorting device includes an optical sensor having a light emitting section that emits detection light toward the sheet and a light receiving section that detects reflected light from the sheet and
when intensity of the reflected light is less than a predetermined threshold, the management section determines that the sheet is the processable sheet.

9. The sheet recycling system according to claim 2, wherein
the sorting device includes a thickness detection section that detects a thickness of the sheet and
the management section determines that the sheet is the processable sheet when the thickness of the sheet detected by the thickness detection section is less than a predetermined threshold value.

10. The sheet recycling system according to claim 2, wherein
the sorting device includes a discharge section configured to discharge the non-processable sheet.

11. A management device configured to calculate a billing amount for printing by a printing device in a sheet recycling system including a sheet manufacturing device that processes a processable sheet suitable for recycling to produce a recycled sheet and the printing device that prints on the recycled sheet manufactured by the sheet manufacturing device, wherein
the management device
acquires first information related to print content when printing is performed using the printing device and second information related to an amount of the processable sheet and
generates third information related to the billing amount based on the first information and the second information.
